(19) United States
(12) Patent Application Publication
(10) Pub. No.: US 2018/0017043 A1
(43) Pub. Date: Jan. 18, 2018

(54) TOWER DAMPER

(71) Applicant: Siemens Aktiengesellschaft, München (DE)

(72) Inventors: Jacob Arbjerg Lindholm Nielsen, Nr. Aaby (DK); Ronald Dannon Redd, Rodding (DK); Alessio Torrielli, Vejle (DK); Frits Wenneker, Delft (NL)

(21) Appl. No.: 15/649,856

(22) Filed: Jul. 14, 2017

(30) Foreign Application Priority Data
Jul. 18, 2016 (EP) 16179946.5

(51) Int. Cl. F03D 7/02; E04H 12/02; E04H 12/00

(52) U.S. Cl. CPC F03D 7/0296; E04H 12/02; F03D 13/20; F03D 7/02; E04H 12/00; F05B 2260/964

(57) ABSTRACT

An arrangement comprising a tower of a wind turbine and a damping device, wherein the tower is situated on a surface. Notably, the damping device is arranged between the tower and the surface. The surface may also been described as the ground or as a floor where the tower is situated on or located at.

### CROSS-REFERENCE TO RELATED APPLICATIONS

This application claims priority to European application No. EP16179946.5, having a filing date of Jul. 18, 2016, the entire contents of which are hereby incorporated by reference.

### FIELD OF TECHNOLOGY

The following relates to an arrangement comprising a tower of a wind turbine and a damping device, wherein the damping device is arranged and prepared to reduce undesired movements of the tower. In particular, the inventive arrangement relates to undesired oscillatory movements of the tower.

### BACKGROUND

A common problem of wind turbine towers are undesired movements of the tower, wherein these undesired movements often times having the characteristics of oscillatory movements. These undesired tower movements mainly occur because a tower of a wind turbine is typically an elongated object having a considerable length. Therefore, the wind turbine tower is exposed to wind which impinges on the wind turbine tower and cause these movements. Oscillation of the wind turbine towers mainly occur during storage of the tower at a storage site, often close to a harbor, or during transportation of the tower on a vessel to an offshore installation site of the wind turbine.

Until now, these undesired tower oscillations have widely been accepted. They are, for instance, encountered by reinforced attachment devices of the tower with regard to the ground where the tower is situated on.

An alternative method to cope with the problem of these undesired movements of the tower are the provision of VIV (vortex induced vibration) strakes which are attached to the tower. Preferred sections of the tower where the VIV strakes are mounted on are the upper third or upper half of the tower.

The drawbacks of the approach to include VIV strakes are safety issues during mounting and dismounting of the VIV strakes to and from the tower, respectively, and the risk that the coating, i.e. paint, of the tower is damaged by the VIV strakes.

In more detail, the safety issue during mounting of the VIV strakes consists of the fact that someone needs to climb up the tower for working on the top platform of the tower, which means that work at a considerable height, for example higher than 100 meter above ground, needs to be carried out. The same problem occurs during dismounting of the VIV strakes. Additionally, additional costs due to the labor work exist. There is also the drawback that are part of strakes are dropped off and hit the ground.

With regard to the damage to the paint, repairing these damages in particular off-shore is very expensive.

Bearing all these drawbacks of the state of the art in mind, an improved concept of reducing movements, in particular oscillatory movements, of the tower of the wind turbine with regard to the ground where the tower is situated on, is desired.

### SUMMARY

An aspect relates to providing an arrangement comprising a tower of a wind turbine and a damping device, wherein the tower is situated on a surface, and wherein the damping device is arranged between the tower and the surface.

Note that embodiments of the present invention are not directed towards a damping device inside or outside of the tower which aims to prevent undesired movements of the tower during operation of the wind turbine. Moreover, embodiments of the present invention propose the provision of a damping device between the tower of the wind turbine and the surface. The surface may also been described as the ground or as a floor where the tower is situated on or located at.

The ground may be part of a deck of a vessel and the tower may be temporarily located on the deck of the vessel. This application of the inventive concept is therefore directed to off-shore wind turbines, i.e. towers of a wind turbine which are used for off-shore installations of wind turbines. The notion “temporarily” includes time spans of a day, several days or weeks but not exceeding a maximum time span of two months.

Another possible situation wherein embodiments of the present invention are useful is the scenario where the tower is situated on or at a storage site ashore and the tower is temporarily located at the storage side ashore, e.g. close to or at a harbor.

Typically, before transportation of the wind turbine tower to the installation site ashore, the tower is stored at a certain area. This area is advantageously located close to the harbor or even is a part of the harbor. During the time at which the tower is actually transported on the vessel to the installation site, the tower is also exposed to wind and therefore may also suffer from undesired movements, for example oscillatory movements. Therefore, it is also desired to reduce and minimize these movements. By providing a damping device between the tower and the surface during this time, a benefit is also reached.

Note that the notion “temporarily” in this context amounts to typically a few days, weeks or a few months. For the temporary storage of the tower at the storage site, extended time spans may apply meaning several months. However, a time span of two years maximum is not exceeded.

Yet, another use or application of embodiments of the present invention is the provision of the damping device between the tower and the surface while the tower is permanently attached to a foundation. Therefore, in this context, the notion “surface” has to be understood as being a part of the foundation of the wind turbine.

A tower is called and understood to be permanently attached if the attachment is present during a time span exceeding two years. In other words, it may also be advantageous to use embodiments of the present invention for a permanent installation of the wind turbine as therefore undesired movements of the tower are permanently minimized.

The tower may be understood as an elongated object with a longitudinal axis. The longitudinal axis of the tower may advantageously be orientated substantially vertical with regard to the surface.

In particular, the tower of the wind turbine is standing on the surface. The present inventive concept is particularly beneficial if the tower is erected and has a substantially vertical orientation.

“Substantial” in this context refers and includes deviations up to 20%, in particular 10% of a perfect vertical orientation.

Note, however, that in principal the concept may also be applied to towers which are arranged in a different orientation, for example an angled orientation comprising an angle smaller than 90 degrees. In principle, the concept may even be applied to horizontally stored towers.

In a particularly beneficial embodiment of the invention, the damping device comprises a laminated elastomeric bearing comprising an inner elastomeric material, in particular rubber, a first connector plate and a second connector plate. The laminated elastomeric bearing is arranged between the two connector plates, wherein the first connector plate is arranged and prepared to be connected to the surface, and the second connector plate is arranged and prepared to be connected to the tower.

The configuration of the damping device, in particular the configuration of the laminated elastomeric bearing being arranged between the two connector plates, may also be described as a sandwich configuration. Such a configuration has been proven to be particularly efficient both with regard to the damping potential and with regard to the ability to tightly and reliably connect the damping device to both the surface and the tower.

In another embodiment of the invention, the damping device furthermore comprises a supporting element, such as an annular frame or a plurality of individual supporting blocks. The first connector plate is connected to the surface via the supporting element.

In other words, in this embodiment of the invention, the damping device is not connected directly to the surface, but a supporting element between the damping device and the ground is included. In other words, the supporting elements such as a frame or individual supporting blocks are a part of the damping device.

In another embodiment of the invention, the tower comprises a base flange, and the second connector plate is connected to the base flange of the tower.

It is common that a tower of a wind turbine comprises a flange at its bottom end. Via this flange the tower is usually connected to the foundation, i.e. to the surface. Therefore, beneficially, the second connector plate of the damping device is connected to the tower at the bottom end, in particular at the base flange of the tower.

In another embodiment of the invention, the damping device furthermore comprises an adaptor plate, and the second connector plate is connected to the base flange of the tower via the adaptor plate.

An advantage of the provision of such an adaptor plate is a facilitated and more efficient actual connection between the second connector plate to the base flange of the tower. Such an adaptor plate may be designed and customized according to the specific specification of the base flange of the tower without the need of adapting the second connector plate of the damping device. Therefore, a more standard setup of the damping device, in particular the second connector plate of the damping device, is possible.

In yet another embodiment of the invention, the adaptor plate is attached to the base flange of the tower by a plurality of bolts. Such a bolt connection of the adaptor plate to the base flange has the advantage that it can easily be carried out when the damping device is connected to the tower of the wind turbine and that such a connection is detachable. In particular, for the case of a temporary use of the damping device, an easy and efficient detachment of the damping device from the tower of the wind turbine is important.

### BRIEF DESCRIPTION

Some of the embodiments will be described in detail, with reference to the following figures, wherein like designations denote like members, wherein:

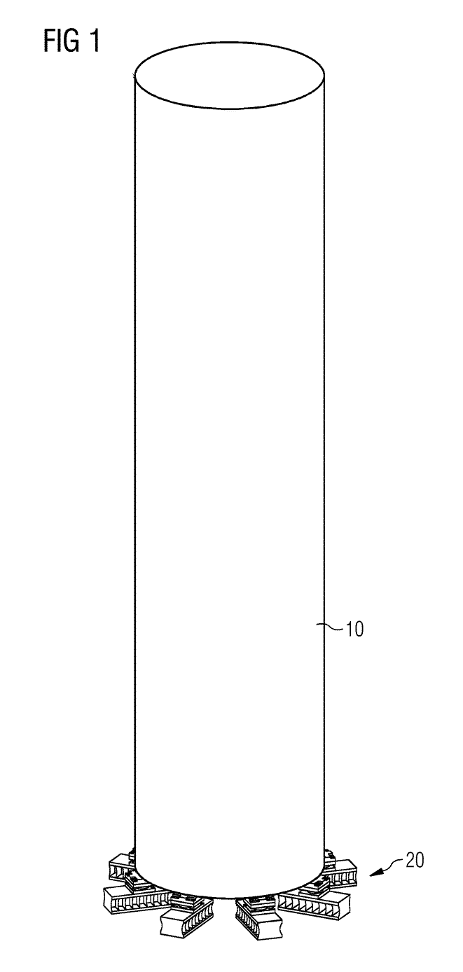

FIG. 1 shows an arrangement comprising a tower of a wind turbine and a damping device;

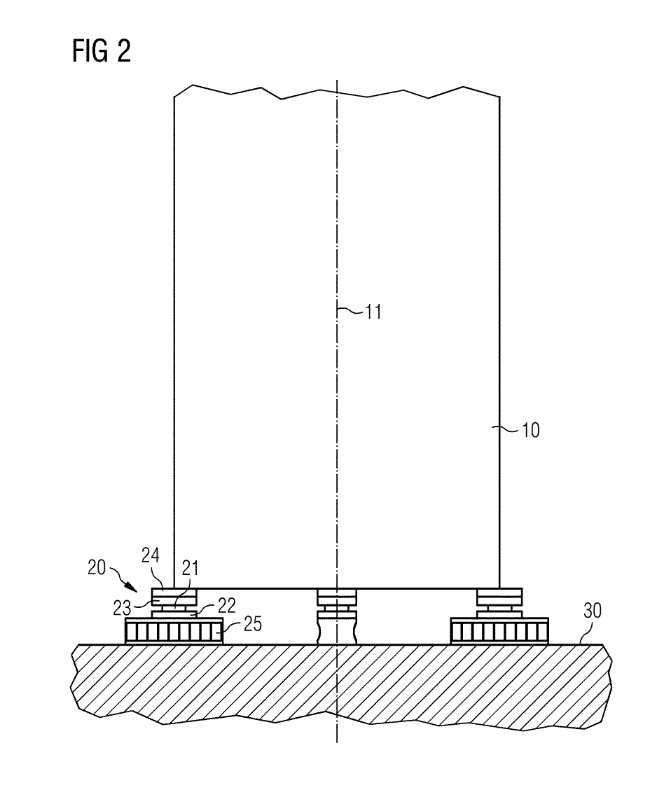

FIG. 2 shows an arrangement comprising a tower of a wind turbine in a damping device in a cross sectional view;

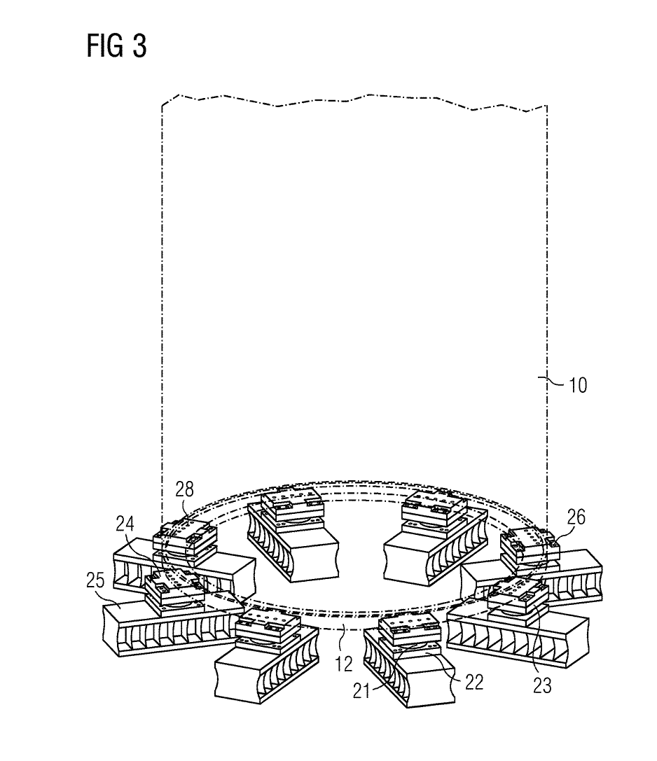

FIG. 3 is a close-up view of a base flange of the tower being connected to a damping device;

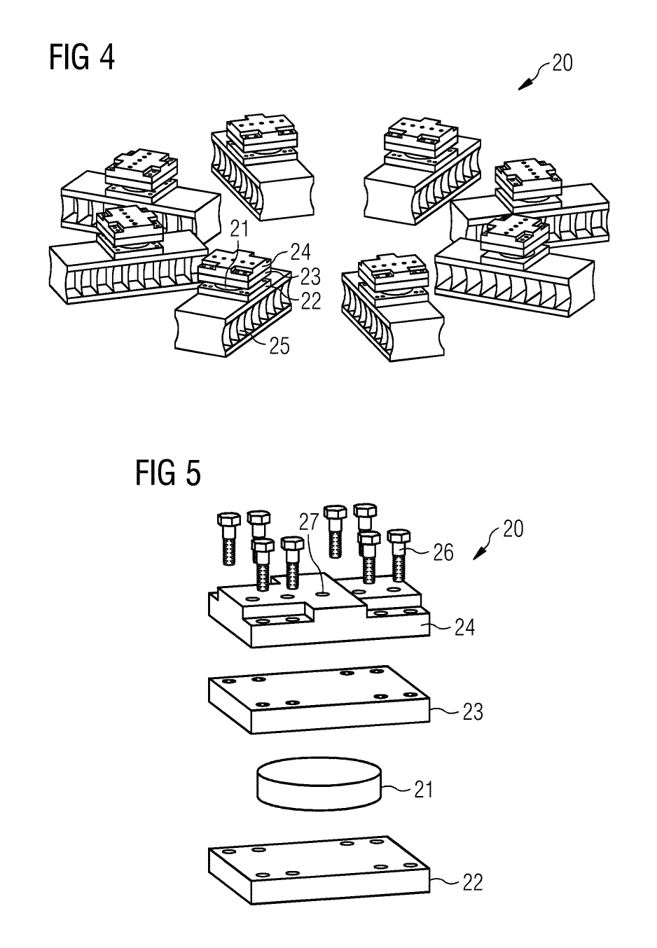

FIG. 4 shows a damping device including several individual supporting blocks; and

FIG. 5 shows an explosion view of an embodiment of a damping device.

The illustration in the drawings is schematically. Note that similar features and elements are denoted by the same reference signs accordingly.

### DETAILED DESCRIPTION

FIG. 1 shows an arrangement comprising a tower 10 of a wind turbine, which is arranged upon a damping device 20. The tower 10 has a tubular shape and is slightly tapered towards the top of the tower. The tower 10 is sitting at its bottom on the damping device 20. The damping device 20 is illustrated in more detail in the following drawings.

A cross sectional view of the inventive arrangement is illustrated in FIG. 2. Therein, a part of a tower 10 of a wind turbine can be seen. The tower 10 has a rotationally symmetric shape such that a longitudinal axis 11 can be assigned to the tower 10. The angle between the longitudinal axes of the tower 11 and the surface 30 is 90 degree. In other words, the tower 10 is vertically directed on the surface 30. However, the tower 10 is not located directly on the surface 30, but a damping device 20 is arranged between the bottom of the tower 10 and the surface. The damping device 20 comprises several individual elements. Each individual element comprises a laminated elastomeric bearing 21, which is sandwiched between a first connector plate 22 and a second connector plate 23. The first connector plate 22 is arranged towards the tower 10. However, there is provided an adaptor plate 24 between the tower 10 and the first connector plate 22. This adaptor plate 24 facilitates the connection between the first connector plate 22 and the bottom end of the tower 10.

The second connector plate 23 is also not directly connected to the surface 30. However there is also for seen a further element which is referred to as a supporting block 25 between the second connector plate 23 and the ground 30. This supporting block 30 is one of several possibilities of a supporting element in general. Alternatively, instead of providing a plurality of individual supporting blocks, there may for example also be provided a circular frame for supporting the remaining parts of the damping device.

FIG. 3 shows a close-up view of the arrangement comprising a tower 10 of a wind turbine and a damping device 20. The tower 10 is shown as comprising a base flange 12 and tower walls which in FIG. 3 are only for sake of clarity drawn as dash-dotted lines. In practice, the tower walls and the base flange 12 may well be manufactured as one piece and the base flange 12, in particular its inner ring, may well be invisible from the outside.

The base flange 12 of the tower 10 is connected to the damping device 20 via a plurality of base flange bolts 28. In the example as illustrated in FIG. 3, five base flange bolts 28 are used for each individual supporting block 25. Note that of course the base flange bolts 28 do not extend through until the supporting blocks 25 but just connect the base flange 12 with the adaptor plate 24.

FIG. 3 furthermore discloses the first connector plate 22, the laminated elastomeric bearing 21 and the second connector plate 23. FIG. 3 also shows the bolts 26 which connect the adaptor plate 24 with the first connector plate 22.

FIG. 4 only shows the damping device 20 without illustrating the tower of a wind turbine. Again, the damping device 20 comprises a plurality of supporting blocks 25 which are directly connected to the first connector plate 22. The first connector plate 22 is connected to the laminated elastomeric bearing 21 which is sandwiched by the second connector plate 23 on the other side. The second connector plate 23 is connected via bolts 26 with an adaptor plate 24.

Finally, FIG. 5 illustrates in an explosion view an embodiment of an inventive damping device. It can be well seen that the damping device comprises as a key element laminated elastomeric bearing 21 which are covered at the top and at the bottom by the first connector plate 22 and the second connector plate 23, respectively. The second connector plate 23 is connected via a plurality of bolts 26 with an adaptor plate 24. Also note the five base flange bores 27 which are drilled into the adaptor plate 24. These base flange bores 27 are arranged and prepared to accommodate and receive the base flange bolts 28, which are for example disclosed in FIG. 3.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An arrangement comprising a tower of a wind turbine and a damping device, wherein the tower is situated on a surface, wherein the damping device is arranged between the tower and the surface.

2. The arrangement according to claim 1, wherein the surface is a part of a deck of a vessel and the tower is temporarily located on the deck of the vessel.

3. The arrangement according to claim 1, wherein the surface is a part of a storage site ashore and the tower is temporarily located at the storage site ashore.

4. The arrangement according to claim 1, wherein the surface is a part of a foundation of the wind turbine and the tower is permanently attached to the foundation.

5. The arrangement according to claim 1, wherein the tower is an elongated object with a longitudinal axis, and the longitudinal axis of the tower is orientated substantially vertical with regard to the surface.

6. The arrangement according to claim 1, wherein the damping device comprises a laminated elastomeric bearing comprising an elastomeric material, a first connector plate and a second connector plate, the laminated elastomeric bearing is arranged between the first connector plate and the second connector plate, the first connector plate is arranged and prepared to be connected to the surface, and the second connector plate is arranged and prepared to be connected to the tower.

7. The arrangement according to claim 1, wherein the damping device furthermore comprises a supporting element, such as an annular frame or a plurality of individual supporting blocks, and the first connector plate is connected to the surface via the supporting element.

8. The arrangement according to claim 1, wherein the tower comprises a base flange, and the second connector plate is connected to the base flange of the tower.

9. The arrangement according to claim 1, wherein the damping device furthermore comprises an adaptor plate, and the second connector plate is connected to the base flange of the tower via the adaptor plate.

10. The arrangement according to claim 9, wherein the adaptor plate is attached to the base flange of the tower by a plurality of bolts.
